(19) United States
(12) Patent Application Publication
(10) Pub. No.: US 2006/0048034 A1
(43) Pub. Date: Mar. 2, 2006

(54) Method and apparatus for transmitting block ACK frame

(75) Inventor: Kyung-ik Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/209,697

(22) Filed: Aug. 24, 2005

(30) Foreign Application Priority Data
Aug. 24, 2004 (KR) 10-2004-0066760

(51) Int. Cl. H04L 1/18

(52) U.S. Cl. 714/749

(57) ABSTRACT

A method and apparatus for transmitting a block acknowledgement (ACK) frame are provided. The method for transmitting a block ACK frame includes receiving a plurality of frames from a transmitting station, receiving a request for transmission of a compressed block ACK frame from the transmitting station, checking the reception status of the plurality of frames received, generating a compressed block ACK frame containing a run-length encoded bitmap field, and sending the compressed block ACK frame to the transmitting station.

### CROSS-REFERENCE TO RELATED APPLICATION

This application claims priority from Korean Patent Application No. 10-2004-0066760 filed on Aug. 24, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to wireless communication, and more particularly, to a block acknowledgement (ACK) transmission mechanism for efficient wireless communication.

2. Description of the Related Art

With increasing demands for wireless networks and transmission of large-capacity multimedia data, there is a need for efficient transmission in a wireless network environment. In a wireless network that allows many stations to share given wireless resources, a collision may occur during communication due to increasing contention, resulting in a waste of resources. To reduce the collision probability and ensure stable data transfer, a contention-based Distributed Coordination Function (DCF) and a contention-free Point Coordination Function (PCF) are used in a wireless local area network (WLAN).

While these methods ensure stable data transfer in a wireless environment without collision, a transfer rate significantly decreases as the number of wireless stations increases because a station needs to wait until another station in the same radio range terminates communication. Thus, ensuring both high data transfer rate and reliable communication in a wireless network environment has become an issue of great concern.

To ensure reliable delivery of data in a wireless network environment, ACK frames are used. To improve a transfer rate, techniques for eliminating unnecessary overhead in data are being developed. The IEEE 802.11e standard specifies various Quality of Service (QoS) techniques including a block ACK mechanism. In a typical ACK scheme defined in the IEEE 802.11 standard, a recipient station sends an ACK frame whenever a frame is successfully received. IEEE 802.11e specifies the conventional ACK scheme as well as a block ACK mechanism that allows a recipient station to send a single block ACK frame for multiple received frames to a transmitting station. The block ACK frame contains information about the reception of all the received frames.

FIG. 1 illustrates a block ACK mechanism defined in the IEEE 802.11e standard.

Referring first to FIG. 1, the block ACK mechanism includes three phases: a set-up phase (S10), a data transfer phase (S20), and a termination phase (S30).

In the set-up phase S10, a transmitting station (originator) sends an ADDBA request frame to a recipient station (recipient) before sending QoS data. The ADDBA request frame contains information indicating the ADDBA request frame, a dialog token field, a block ACK parameter set field, and a block ACK timeout value.

The recipient that receives the ADDBA request frame sends an ADDBA response frame to the originator. The ADDBA response frame contains information indicating the ADDBA response frame, the dialog token field extracted from the ADDBA response frame, an ADDBA status code field, a block ACK parameter set field, and a block ACK timeout value.

Following the ADDBA request and the ADDBA response, the data transfer phase S20 commences. In the data transfer phase S20, the originator sends multiple frames to the recipient. After sending all frames, the originator sends a block ACK request frame to the recipient. The recipient then responds with a block ACK response frame. The formats of the block ACK request frame and the block ACK response frame will be described in detail below.

After the originator receives the block ACK frame from the recipient, the termination phase S30 starts. The originator sending a DELBA request frame to the recipient. The DELBA request frame contains information indicating the DELBA request frame and a DELBA parameter field.

FIG. 2 illustrates a format of a block ACK request frame defined in the IEEE 802.11e standard.

Referring to FIG. 2, the block ACK request frame 20 includes a Medium Access Control (MAC) header 21, a block ACK request (BAR) Control field 22 consisting of a target identifier (TID) field 222 and a reserved field 220 used to control the block ACK request frame 20, a Block ACK Starting Sequence Control field 23 consisting of a fragment number field 230 and a sequence number field 232 corresponding to a first MAC Protocol Data Unit (MPDU), and a Frame Check Sequence (FCS) field 24 used for computing a checksum error.

FIG. 3 illustrates a format of a block ACK frame defined in the IEEE 802.11e,

Referring to FIG. 3, a block ACK frame 30 includes an MAC header 31, a block ACK (BA) Control field 32 consisting of a Traffic Identifier (TID) field 322 and a reserved field 320 used to control the block ACK frame 30, a Block ACK Starting Sequence Control field 33 consisting of a fragment number field 330 and a sequence number field 332 that respectively specify a fragment number and a sequence number corresponding to a first MAC Protocol Data Unit (MPDU), a Block ACK Bitmap field 34 sequentially specifying “ACK information” for the subsequent MPDUs (indicating whether specific data was correctly received), and an FCS field 35 used for computing a checksum error.

Since the Block ACK Bitmap field 34 is 128 bytes in length where 2 bytes are needed to acknowledge each MAC Service Data Unit (MSDU), it can specify ACK information for up to 64 MSDUs. That is, since each MSDU can be partitioned into up to 16 fragments in the IEEE 802.112e standard, 16 bits (2 bytes) are allocated to acknowledge each MSDU. Two bytes are equally allocated even if the MSDU is not actually fragmented or partitioned into fragments less than 16. However, in this case, it is not efficient to represent the ACK information for each MSDU using one bit. Thus, using two bytes to represent one MSDU results in an excessive increase in a block ACK frame size.

Thus, it is highly desirable to provide a new block ACK frame with smaller size than, but the same function as, a conventional block ACK frame.

### SUMMARY OF THE INVENTION

The present invention provides a method and apparatus for efficiently transmitting a block ACK frame.

According to an aspect of the present invention, there is provided a method for transmitting a block ACK frame including receiving a plurality of frames from a transmitting station; receiving a request for transmission of a compressed block ACK frame from the transmitting station; checking the reception status of the plurality of frames received, generating a compressed block ACK frame containing a run-length encoded bitmap field, and sending the compressed block ACK frame to the transmitting station.

According to another aspect of the present invention, there is provided a method for transmitting a block ACK frame, including receiving a plurality of frames from a transmitting station, receiving a request for transmission of a compressed block ACK frame from the transmitting station, checking the reception status of the plurality of frames received, determining whether the compressed block ACK frame is shorter than a reference value, generating a compressed block ACK frame when the compressed block ACK frame is shorter than the reference value, and sending the compressed block ACK frame to the transmitting station.

According to still another aspect of the present invention, there is provided a station including an MAC module checking whether multiple frames have been received correctly, a block ACK selecting module generating a compressed Block ACK Bitmap field according to whether the multiple received frames are in errors and providing the compressed Block ACK Bitmap field to the MAC module that generates a compressed block ACK frame, and a physical layer module receiving the compressed block ACK frame generated by the MAC module for transmission.

### BRIEF DESCRIPTION OF THE DRAWINGS

The above and/or other aspects of the present invention will become more apparent by describing in detail exemplary embodiments thereof with reference to the attached drawings in which:

FIG. 1 is a sequence diagram of a block ACK mechanism defined in the IEEE 802.11e;

FIG. 2 illustrates a format of a block ACK request frame defined in the IEEE 802.11e;

FIG. 3 illustrates a format of a block ACK frame defined in the IEEE 802.11e;

FIG. 4 illustrates a format of a block ACK frame according to an exemplary embodiment of the present invention;

FIG. 5 illustrates a format of a Block ACK Bitmap field in a block ACK frame according to a first exemplary embodiment of the present invention;

FIG. 6 illustrates a format of a block ACK request frame according to an exemplary embodiment of the present invention;

FIG. 7 is a flowchart illustrating a process of transmitting a block ACK frame according to a first exemplary embodiment of the present invention;

FIG. 8 is a flowchart illustrating a process of transmitting a block ACK frame according to a second exemplary embodiment of the present invention;

FIG. 9 illustrates a format of a Block ACK Bitmap field in a block ACK frame according to a second exemplary embodiment of the present invention; and

FIG. 10 is a block diagram of a station according to an exemplary embodiment of the present invention.

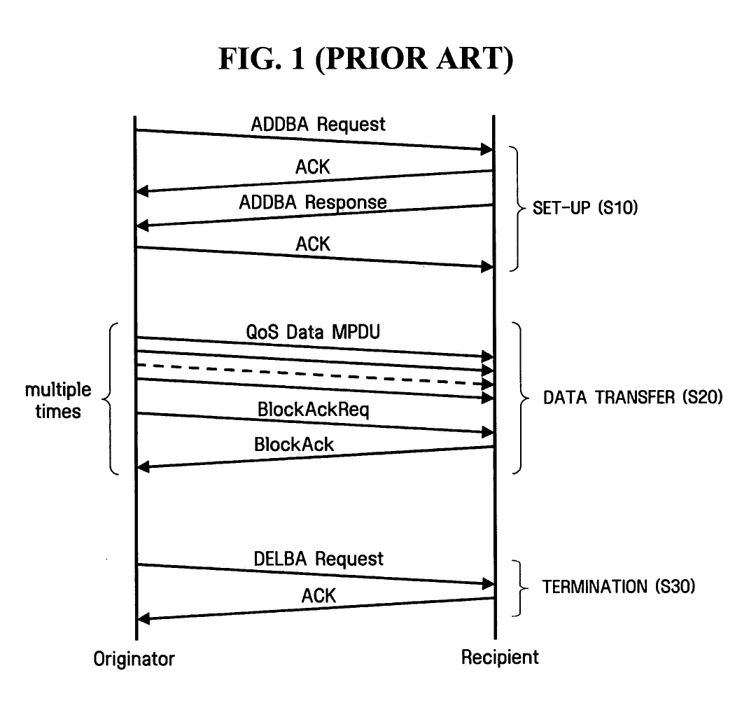

### DETAILED DESCRIPTION OF EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

The present invention will now be described more fully with reference to the accompanying drawings, in which exemplary embodiments of the invention are shown.

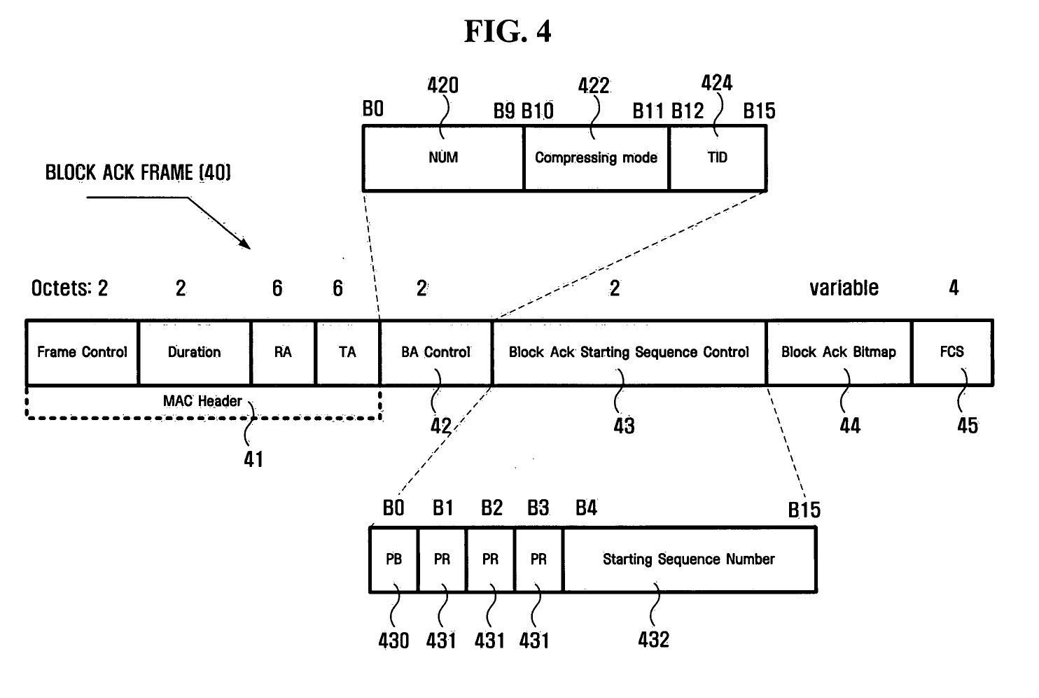

FIG. 4 illustrates a format of a block ACK frame according to an exemplary embodiment of the present invention.

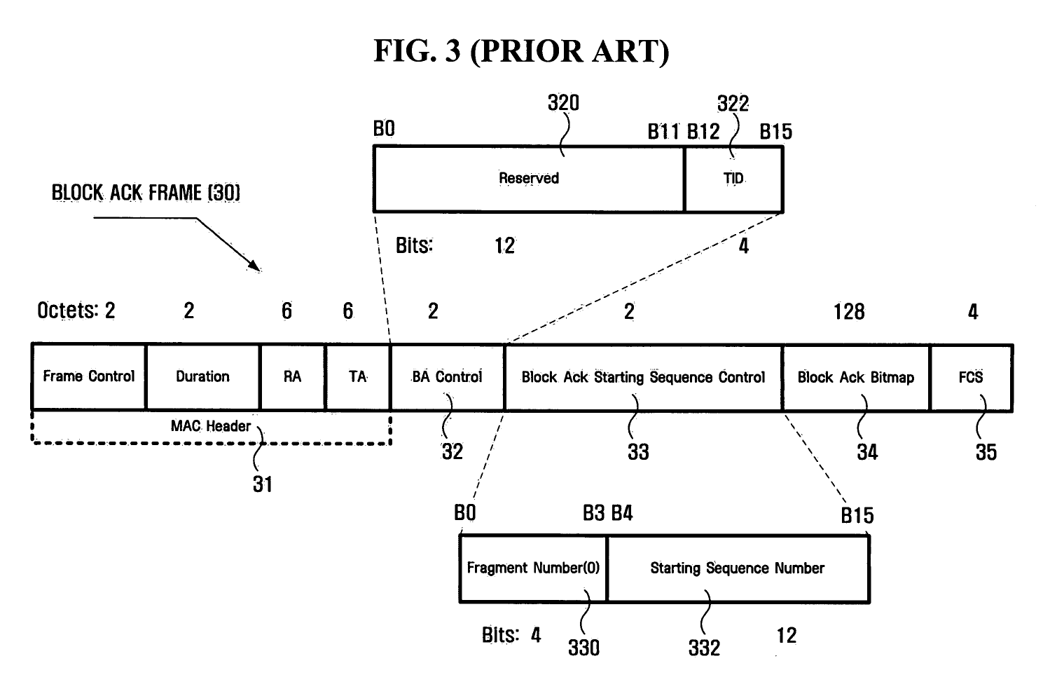

Referring to FIG. 4, like the conventional block acknowledgement (ACK) frame 30 shown in FIG. 3, a block ACK frame 40 according to an exemplary embodiment of the present invention includes an MAC header 41, a BA Control field 42 used to control the block ACK frame 40, a Block ACK Starting Sequence Control field 43, a Block ACK Bitmap field 44, and an FCS field 45 used for computing a checksum error.

The MAC header 41 consists of a Frame Control field, a Duration field, a Receiver Address (RA) field, and a Transmitter Address (TA) field.

Like in the conventional block ACK frame 30, the Frame Control field contains information indicating that the type of the block ACK frame 40 is ‘control’ and information indicating the subtype is a block ACK frame.

The Duration field is set to the same value as in the conventional block ACK frame 30. That is, when the block ACK frame 40 is sent in response to a block ACK request frame, the Duration field is set to a time, in microseconds, which is greater than or equal to a value obtained from a Duration field of the block ACK request frame minus the amount of time required to transmit the block ACK frame 40 and one short interframe space (SIFS) interval. On the other hand, when the block ACK frame 40 is not sent in response to the block ACK request frame, the Duration field is set to a time, in microseconds, which is greater than or equal to the amount of time required to transmit one ACK frame plus its SIFS interval.

The RA field and TA field are respectively set to MAC addresses of a recipient station and a transmitting station.

The BA Control field 42 consists of an NUM field 420, a Compressing Mode field 422, and a TID field 424. The two-bit Compressing Mode field 422 specifies the compression mode of the Block ACK Bitmap field 44. The NUM field 420 specifies the total number of fragments.

The Block ACK Starting Sequence Control field 43 consists of a PB field 430, a PR field 431, and a Starting Sequence Number field 432.

The PR field 431 is set when all frames are received without an error while the PB field 430 is set when there is no frame received without an error. An error means damage to some bits in a frame or failure to receive a frame. The PR field 431 takes the form of a repetition code that is resilient to transmission errors.

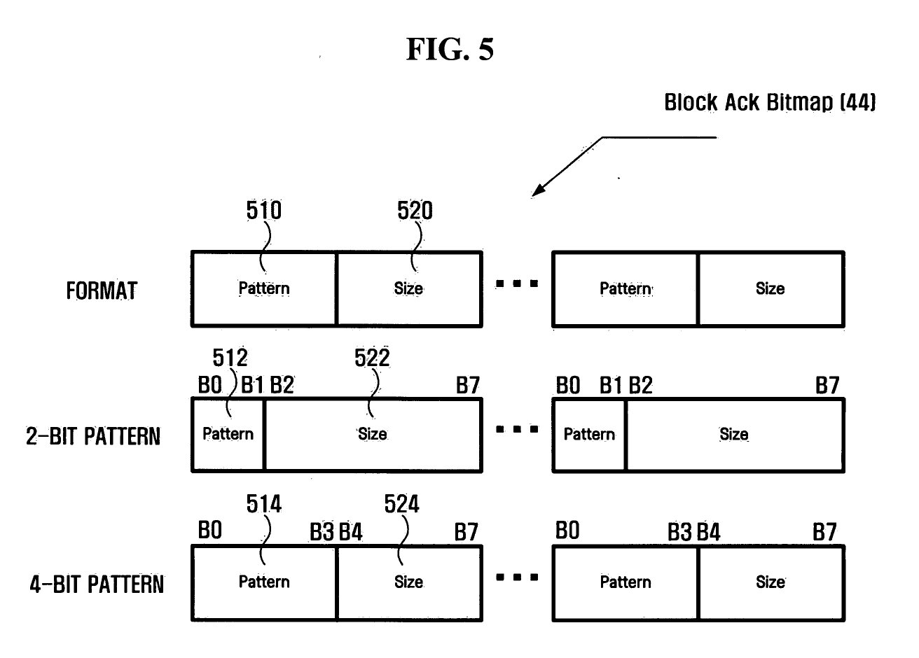

Unlike in the conventional block ACK frame 30 shown in FIG. 3, the block ACK Bitmap field 44 has a variable length which will be described in detail below with reference to FIG. 5.

The FCS field 45 is used for computing a checksum error.

FIG. 5 illustrates a format of a Block ACK Bitmap field 44 in a block ACK frame according to a first exemplary embodiment of the present invention.

Referring to FIG. 5, the Block ACK Bitmap field 44 contains a value obtained by compressing a conventional block ACK bitmap using Run-Length encoding.

The Block ACK Bitmap field 44 basically contains at least one pair of a pattern field 510 and a size field 520. The pair of the pattern field 510 and the size field 520 may have a one-byte length.

The pattern field 510 is used to represent the pattern of the reception status for frames. The size of the pattern field 510 may vary depending on the number of frames to represent one pattern. As illustrated in FIG. 5, when each pattern is represented for two frames, a two-bit pattern field 512 and a six-bit size pattern field 522 are used. When the pattern is represented for four frames, a four-bit pattern field 514 and a four-bit size field 524 are used.

In the present exemplary embodiment, the Block ACK Bitmap field 44 is compressed using Run-Length coding since consecutive frame errors tend to occur during block transmission. For example, it is assumed that 48 frames are transmitted and correctly-received frames (represented by “1”) and incorrectly-received frames (represented by “0”) are represented by “1111111111 1110000000 0000000000 00000000000 10101000”. The conventional Block ACK Bitmap field has a fixed length of 128 bytes while using only 48 bytes. Conversely, the Block ACK Bitmap field 44 has a shorter length than the conventional one. That is, when two frames represent one pattern, a total of five bytes are needed: 11 (6), 10 (1), 00 (13), 10 (3), and 00 (1). When four frames represent one pattern, a total of five bytes are also needed: 1111 (3), 1000 (1), 0000 (6), 1010 (1), and 1000 (1). That is, while the conventional block ACK frame is 152 bytes in length, including the 128-byte Block ACK Bitmap field, a block ACK frame of the present invention is 29 bytes in length. Eventually, the block ACK frame of the present invention has a shorter length than the conventional one. The shorter frame length reduces the data transmission time as well as the possibility for errors in the block ACK frame.

Meanwhile, when the PB field 430 and the PR field 431 are used, the Block ACK Bitmap field 44 may not be required. That is, the recipient station sets the PB field 430 when errors occur in all frames or no frame is received while setting the PR field 431 when all the frames are normally received. In this case, the length of the block ACK frame is 24 bytes.

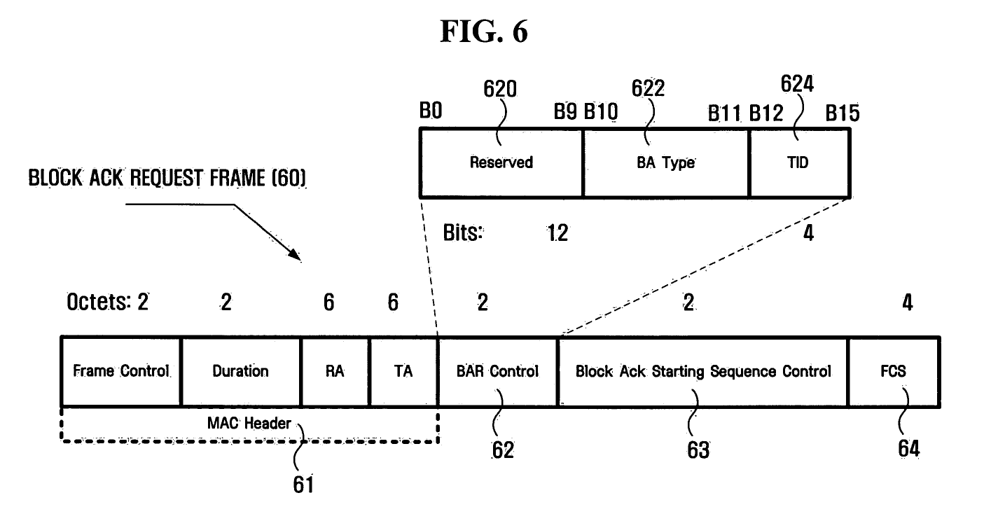

FIG. 6 illustrates a format of a block ACK request frame 60 according to an exemplary embodiment of the present invention.

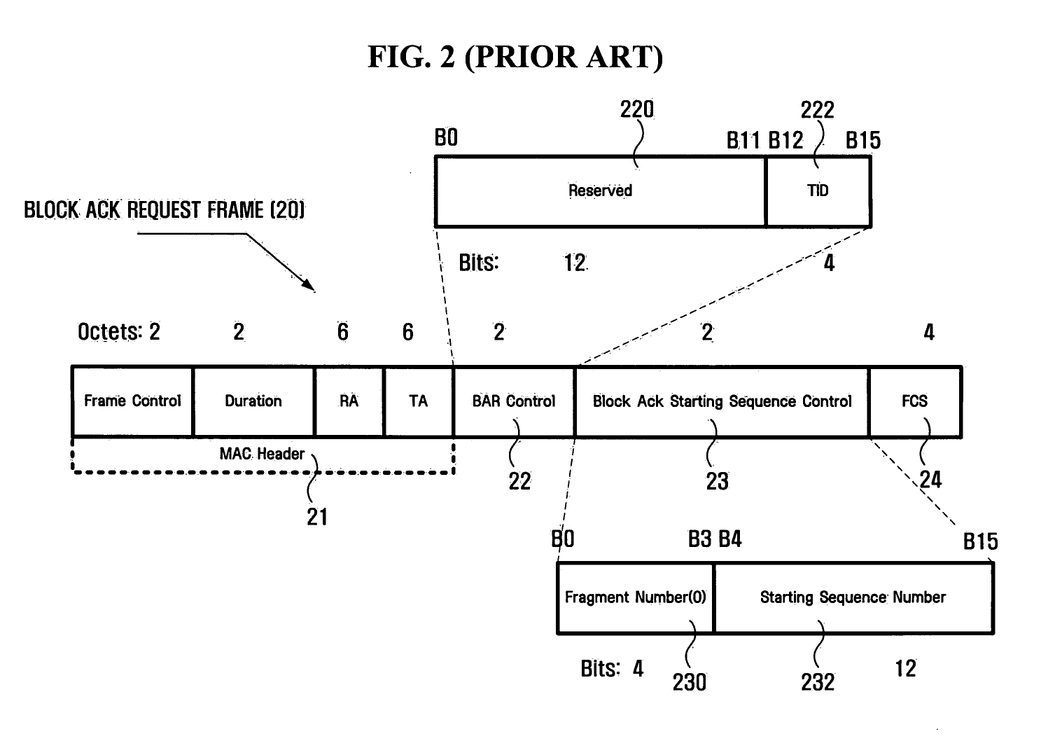

Referring to FIG. 6, like the block ACK frame 20 shown in FIG. 2, the block ACK request frame 60 includes an MAC header 61, a BAR Control field 62, a Block ACK Starting Sequence Control field 63, and an FCS field 64 used for computing a checksum error.

The BAR Control field 62 includes a reserved field 620 and a TID field 624. Unlike the conventional block ACK request frame 20, the BAR Control field 62 further includes a BA Type field 622.

The BA Type field 622 defines the type of a block ACK frame that a recipient station intends to transmit. For example, a transmitting station, intending to receive the conventional block ACK frame, may set the BA Type field to “00.” The transmitting station, intending to receive the block ACK frame according to the present invention, may set the same field to “01.” Values “10” and “11” may be reserved for another block ACK frame.

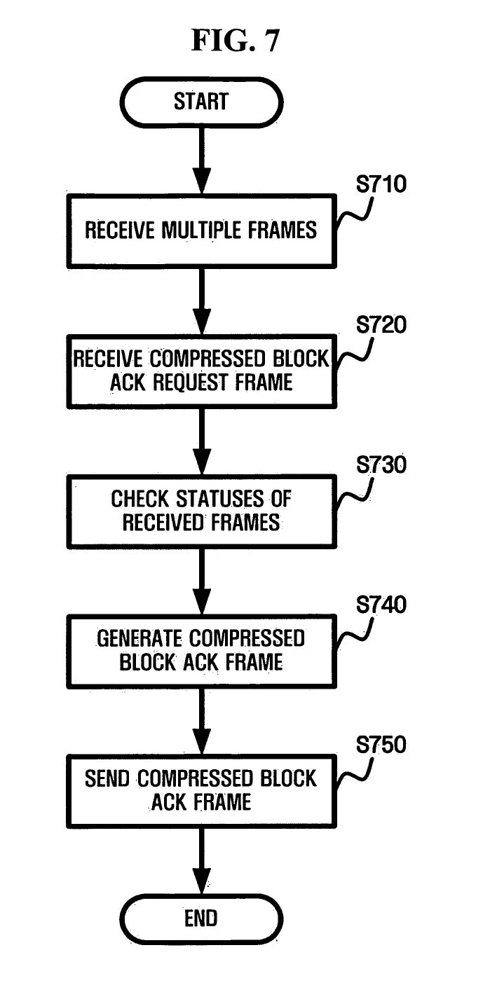

FIG. 7 is a flowchart illustrating a process of transmitting a block ACK frame according to a first exemplary embodiment of the present invention.

Referring to FIG. 7, in operation S710, a recipient station receives multiple frames sent from a transmitting station.

In operation S720, the recipient station receives a compressed block ACK request frame requesting a block ACK frame containing a compressed Block ACK Bitmap field according to the present invention (i.e., a “compressed block ACK frame”) sent by the transmitting station after the multiple frames. Through a BAR control field in the received block ACK request frame, the recipient station is able to know that the block ACK request frame requests a compressed block ACK frame.

In operation S730, the recipient station that receives the compressed block ACK request frame checks the reception status of the multiple frames received in the operation S710. In other words, it checks whether each frame has been received correctly or with an error.

In operation S740, after checking the reception status of the multiple frames, the recipient station generates a compressed block ACK frame to be sent to the transmitting station.

In operation S750, the recipient station sends the compressed block ACK frame to the transmitting station.

When the recipient station does not support the compressed block ACK frame according to the present invention, it recognizes the received frame as a block ACK request frame in the operation S720 and sends a conventional block ACK frame to the transmitting station. That is, the compressed block ACK frame according to the present invention is not newly defined but distinguished by a reserved field in the conventional block ACK frame. Thus, a station supporting the compressed block ACK frame according to the present invention is compatible with a station not supporting the compressed block ACK frame.

In some cases, the compressed block ACK frame may be less efficient than the conventional block ACK frame. That is, when the pattern of frames received with errors is irregular, the efficiency of run-length coding may decrease. Thus, the recipient station that receives a request for the compressed block ACK frame needs to send the conventional block ACK frame instead of the compressed block ACK frame according to the status of received frames.

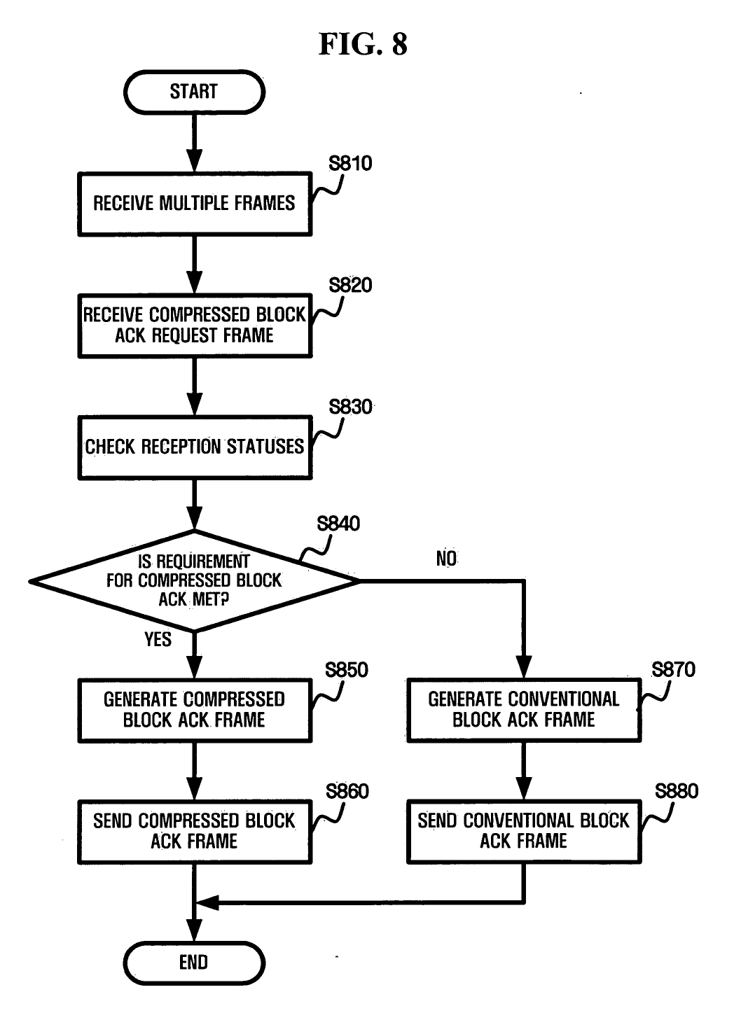

FIG. 8 is a flowchart illustrating a process of transmitting a block ACK frame according to a second exemplary embodiment of the present invention.

Referring to FIG. 8, in operation S810, a recipient station receives multiple frames sent by a transmitting station.

In operation S820, the recipient station receives a compressed block ACK request frame according to the present invention sent by the transmitting station after the multiple frames. Like in the method illustrated in FIG. 7, the recipient station is able to know that the received block ACK request frame requests a compressed block ACK frame through a BAR control field in the block ACK request frame.

In operation S830, the recipient station that receives the compressed block ACK request frame checks the reception status of the multiple frames received in the operation S810. In other words, it checks whether each frame has been received correctly or with an error.

In operation S840, after checking the reception status of the multiple frames, the recipient station determines whether a requirement for a compressed ACK frame will be satisfied. The requirement for compressed block ACK frame is satisfied when the compressed block ACK frame is shorter than a reference value, e.g., a conventional block ACK frame. To determine which frame is shorter, the lengths of Block ACK Bitmap fields in both frames are compared.

When the requirement for compressed block ACK frame is met, the recipient station generates a compressed block ACK frame in operation S850 and the sends the compressed block ACK frame to the transmitting station in operation S860.

On the other hand, when the requirement for compressed block ACK frame is not met, the recipient station generates a conventional block ACK frame in operation S870 and sends the conventional block ACK frame to the transmitting station in operation S880. Like in the first exemplary embodiment illustrated in FIG. 7, the recipient station that does not support the compressed block ACK frame according to the present invention recognizes the received frame as a conventional block ACK request frame in the operation S820 and sends a conventional block ACK frame to the transmitting station.

The block ACK frame compressed using run-length coding may have a different format than described above. For example, the block ACK frame may contain a Block ACK Bitmap field which is partially modified.

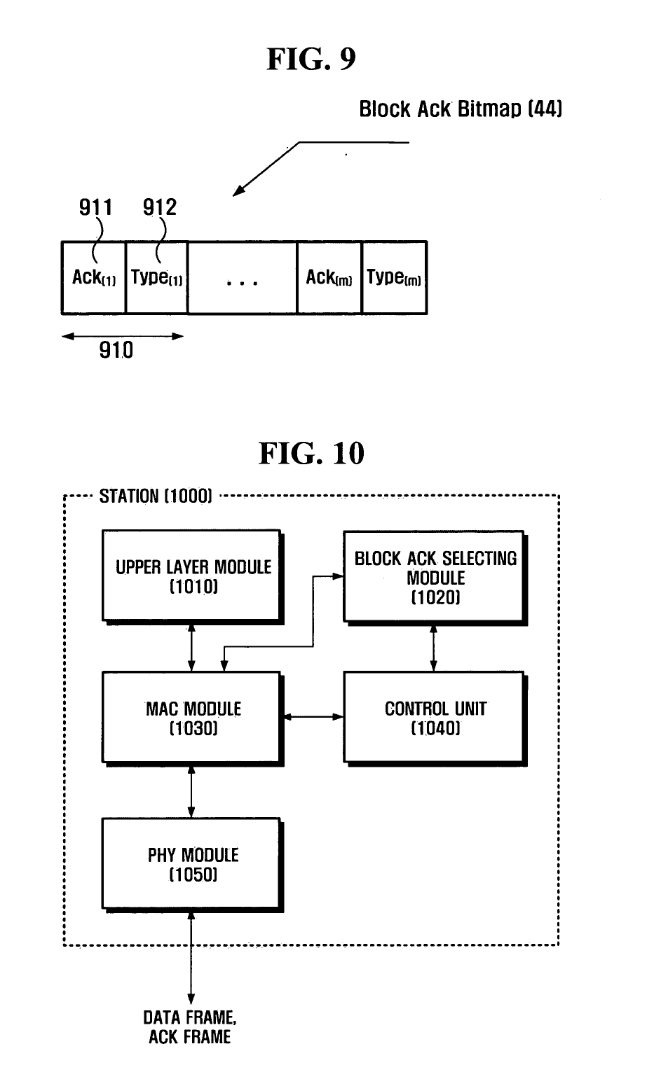

FIG. 9 illustrates a format of a Block ACK Bitmap field 44 in a block ACK frame according to a second exemplary embodiment of the present invention.

The Block ACK Bitmap field 44 sequentially specifies bit pairs 910 of ACK bit 91 1 and Type bit 912 for a target frame. The minimum number m of bit pairs 910 is equal to the total number of MSDUs while the maximum number of bit pairs is equal to the total number of fragments. A frame is composed of one MSDU when no fragmentation occurs. When an MSDU is divided into several fragments, the frame is composed of some fragments of the MSDU.

The ACK bit 911 in the Block ACK Bitmap field 44 specifies whether a frame has been normally received. For example, the ACK bit 911 may be set to “1” when the frame is normally received and to “0” when it is received with an error.

The Type bit 912 specifies bit information indicating whether the ACK bit represents an ACK for the frame (MSDU or fragment) or an ACK for all fragments in the MSDU following the current fragment. The type bit 912 may be set to “0” in the former case or to “1” in the latter case.

Assuming that the 48 frames described earlier consist of 4 MSDUs with 10 fragments and 1 MSDU with 8 fragments, the bit pairs 910 may be represented as (1,1), (1,0)(1,0)(1,0)(0,0)(0,0)(0,0)(0,0)(0,0)(0,0)(0,0), (0,1), (0,1), (1,0)(0,0)(1,0)(0,0)(1,0)(0,0) (0,0)(0,0) in order to represent “1111111111 1110000000 0000000000 00000000000 10101000”. (1,1) indicates that all fragments in a first MSDU was correctly received and (1,0)(1,0)(1,0)(0,0)(0,0)(0,0)(0,0)(0,0)(0,0)(0,0) indicate the reception statuses of fragments in a second MSDU. (0,1) indicates that no fragment in a third MSDU was correctly received, (0,1) indicates that no fragment in a fourth MSDU was correctly received, and (1,0)(0,0)(1,0)(0,0)(1,0)(0,0)(0,0)(0,0) represent the reception statuses of fragments in a fifth MSDU. In this case, a total of 42 bits (6 bytes) are sufficient to represent a Block ACK Bitmap.

The compressed block ACK frame which has been described above should be construed as being illustrative and may have various other formats.

FIG. 10 is a block diagram of a station 1000 according to an exemplary embodiment of the present invention.

Referring to FIG. 10, the station 1000 includes an upper layer module 1010, a block ACK selecting module 1020, an MAC module 1030, a control unit 1040, and a Physical Layer (PHY) module 1050.

The MAC module 1030 manages operation at an MAC layer. That is, the MAC module 1030 receives an MSDU from the upper layer module 1010, adds an MAC header to the MSDU, and delivers the resulting frame to the PHY module 1050.

The MAC module 1030 also generates a block ACK frame containing a Block ACK Bitmap field generated by the block ACK selecting module 1020 and delivers the block ACK frame to the PHY module 1050. Furthermore, upon receiving a frame transmitted by another station from the PHY module 1050, the MAC module 1030 reads an MAC header, removes the MAC header from the frame, and transmits the result to the upper layer module 1010. That is, the MAC module 1030 checks an error through an FCS field in the frame sent by the other station and removes the MAC header from the frame when there is no error, and passes the resulting frame to the upper layer module 1010.

The upper layer module 1010 generates an MSDU and transmits the MSDU to the MAC module 1030 while receiving data from which an MAC header has been removed from the MAC module 1030. The upper layer module 1010 manages a network layer above a logical link control (LLC) layer.

The PHY module 1050 manages operation at PHY. That is, the PHY module 1050 receives an MPDU from the MAC module 1030 to generate a Packet Protocol Data Unit (PPDU) and a radio signal containing the PPDU that are then transmitted to the MAC module 1030. The PHY module 1050 also receives a signal through a wireless medium and processes the signal that is then transmitted to the MAC module 1030. The PHY module 1050 is subdivided into a base band processor and a radio frequency (RF) module.

The block ACK selecting module 1020 generates a Block ACK Bitmap field according to the statuses of received frames and transmits the Block ACK Bitmap field to the MAC module 1030. More specifically, the block ACK selecting module 1020 checks whether each of the frames received from the MAC module 1030 has been received correctly or with an error and generates a Block ACK Bitmap using the result. When a frame received by the station 1000 is a compressed block ACK request frame, the block ACK selecting module 1020 generates a compressed Block ACK Bitmap field. Alternatively, when a frame received by the station 1000 is a compressed block ACK request frame, the block ACK selecting module 1020 generates a compressed Block ACK Bitmap field when the compressed Block ACK Bitmap field is shorter than a conventional Block ACK Bitmap field or the conventional Block ACK Bitmap field when the compressed Block ACK Bitmap field is not shorter than the conventional Block ACK Bitmap field.

The control unit 1040 controls the operation of another module within the station 1000 and may be implemented by a central processing unit (CPU), a microcomputer, or the like.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they are executed on one or more computers in a communication system.

As described above, the method and apparatus according to the present invention enable efficient wireless network communication using the block ACK frame. The shorter block ACK frame length reduces the data transmission time as well as the possibility for errors that may occur during transmission of the block ACK frame.

It is to be appreciated that the above described exemplary embodiments are for purposes of illustration only and not to be construed as a limitation of the invention. The scope of the invention is given by the appended claims, rather than the preceding description, and all variations and equivalents which fall within the range of the claims are intended to be embraced therein.

What is claimed is:

1. A method for transmitting a block acknowledgement (ACK) frame, the method comprising:
receiving a plurality of frames from a transmitting station;
receiving a request for transmission of a compressed block ACK frame from the transmitting station;
checking a reception status of the frames;
generating the compressed block ACK frame containing a run-length encoded bitmap field; and
sending the compressed block ACK frame to the transmitting station.

2. The method of claim 1, wherein the bitmap field contains at least one pair of a pattern field specifying patterns for the frames and a size field representing a number of repetitions of the patterns recorded in the pattern field.

3. The method of claim 2, wherein the pair of the pattern field and the size field are one byte in length.

4. The method of claim 2, wherein the pattern field is one of a two-bit pattern and a four-bit pattern.

5. The method of claim 1, wherein the compressed block ACK frame includes a first field used to indicate that all of the frames are received without an error and a second field used to indicate that all of the frames are received with errors.

6. The method of claim 5, wherein the first field is in the form of a repetition code.

7. A method for transmitting a block acknowledgement (ACK) frame, the method comprising:
receiving a plurality of frames from a transmitting station;
receiving a request for transmission of a compressed block ACK frame from the transmitting station;
checking a reception status of the frames;
determining whether the compressed block ACK frame is shorter than a reference value;
generating the compressed block ACK frame if it is determined that the compressed block ACK frame is shorter than the reference value; and
sending the compressed block ACK frame to the transmitting station.

8. The method of claim 7, further comprising generating an uncompressed block ACK frame representing the reception status of the frames if the compressed block ACK frame is longer than the reference value, and sending the uncompressed block ACK frame to the transmitting station.

9. The method of claim 8, wherein the reference value is a length of the uncompressed block ACK frame.

10. The method of claim 7, wherein the compressed frame contains a run-length encoded bitmap representing the reception status of the frames.

11. The method of claim 10, wherein the bitmap field contains at least one pair of a pattern field specifying patterns for the frames and a size field representing a number of repetitions of the patterns recorded in the pattern field.

12. The method of claim 11, wherein the pair of the pattern field and the size field are one byte in length.

13. The method of claim 11, wherein the pattern field is one of a two-bit pattern and a four-bit pattern.

14. The method of claim 7, wherein the compressed block ACK frame includes a first field used to indicate that all of the frames are received without an error and a second field used to indicate that all of the frames are received with errors.

15. The method of claim 14, wherein the first field is in the form of a repetition code.

16. A station comprising:
a Media Access Control (MAC) module which checks whether multiple frames have been received correctly;
a block acknowledgement (ACK) selecting module which generates a compressed Block ACK Bitmap field according to whether the multiple frames are received with errors, and provides the compressed Block ACK Bitmap field to the MAC module which generates the compressed block ACK frame; and
a physical layer module which receives the compressed block ACK frame generated by the MAC module for transmission.

17. The station of claim 16, wherein if a length of the compressed Block ACK Bitmap field is greater than or equal to a length of an uncompressed Block ACK Bitmap field, the block ACK selecting module provides the uncompressed Block ACK Bitmap field to the MAC module which generates an uncompressed block ACK frame.

18. A computer readable recording medium on which a computer readable program for executing a method for transmitting a block acknowledgement (ACK) frame is recorded, the method comprising:
receiving a plurality of frames from a transmitting station;
receiving a request for transmission of a compressed block ACK frame from the transmitting station;
checking a reception status of the frames;
generating the compressed block ACK frame containing a run-length encoded bitmap field; and
sending the compressed block ACK frame to the transmitting station.

19. A computer readable recording medium on which a computer readable program for executing a method for transmitting a block acknowledgement (ACK) frame is recorded, the method comprising:
receiving a plurality of frames from a transmitting station;
receiving a request for transmission of a compressed block ACK frame from the transmitting station;
checking the reception status of the frames;
determining whether the compressed block ACK frame is shorter than a reference value;
generating the compressed block ACK frame if it is determined that the compressed block ACK frame is shorter than the reference value; and
sending the compressed block ACK frame to the transmitting station.
